(19) United States
(12) Patent Application Publication
(10) Pub. No.: US 2017/0051591 A1
(43) Pub. Date: Feb. 23, 2017

(54) Systems and Methods for Providing Power and Communications for Downhole Tools

(71) Applicant: Baker Hughes Incorporated, Houston, TX (US)

(72) Inventor: Jeffrey R. Honekamp, Tomball, TX (US)

(73) Assignee: Baker Hughes Incorporated, Houston, TX (US)

(21) Appl. No.: 15/166,499

(22) Filed: May 27, 2016

Related U.S. Application Data
(60) Provisional application No. 62/206,361, filed on Aug. 18, 2015.

(51) Int. Cl. E21B 43/12; H02P 31/00; H02J 5/00; E21B 17/00

(52) U.S. Cl. CPC E21B 43/128; E21B 17/003; H02P 31/00; H02J 5/00; E21B 33/04

(57) ABSTRACT

Systems and methods for conveying power and data between surface equipment, an ESP and one or more remote tools while requiring a reduced number of penetrations through a tubing hanger. In one embodiment, a primary cable carries power and data between surface equipment and the ESP. A separate secondary cable is coupled between the ESP and the remote tools. The ESP receives power from the surface equipment via the primary cable, and the remote tools receive power from the ESP via the secondary cable. A step-down transformer in the ESP transforms power to reduced-voltage AC power, or a rectifier produces rectified DC power which is provided to the remote tools via the secondary cable. A transceiver in the ESP communicates data between the surface equipment and the remote tools. Data and power for the ESP and remote tools are conveyed through a single common penetration in a tubing hanger.

### CROSS-REFERENCE TO RELATED APPLICATIONS

This application claims the benefit of U.S. Provisional Patent Application 62/206,361, filed Aug. 18, 2015 by Jeffrey R. Honekamp, which is incorporated by reference as if set forth herein in its entirety.

### BACKGROUND

Field of the Invention

The invention relates to systems for providing power to and enabling communication with electric tools that are positioned in a well below an electric submersible pump (ESP) while reducing the number of penetrations through a tubing hanger for the well.

Related Art

Artificial lift systems such as pumps may be used to produce fluids (e.g., oil) from wells. ESP's are commonly used for this purpose. An ESP may be coupled to production tubing that can then be used to lower the ESP into the well. The production tubing is supported in the well by a tubing hanger in the well head at the surface of the well. In subsea wells, the well head and tubing hanger are positioned at the seabed, and the production tubing in the well is coupled through the well head and tubing hanger to a conduit that extends to a production platform or vessel topside at the sea surface, or to a land-based platform or facility.

In deep-sea applications, the sea bed may be on the order of 10,000 feet deep, and the ESP may be 10,000 feet below the sea bed. The well may extend even deeper than this and, in some cases, additional tools such as valves or sensors may be positioned in the well below the ESP. These tools may, for example, be another 10,000 feet below the ESP.

Power and control information for the ESP are provided by equipment at the surface of the well (or the sea surface). The power is carried to the ESP via a power cable. The control information and information sensed in the well may be communicated between the surface and the ESP through dedicated lines, or over the power cable. Systems that communicate data via the power cable are sometimes referred to as “comms on” power systems.

Power and control information for tools or devices positioned below the ESP in the well are conventionally carried by dedicated TEC lines which are separate from the ESP power/data lines. Each of these TEC lines separately penetrates the tubing hanger. The number of TEC lines that can be provided is limited by the number of penetrations that can physically be made through the tubing hanger. The number is also limited by the amount of space within the well bore itself. Further, the additional penetrations may be disadvantageous because they increase the cost and complexity of the well system.

It would therefore be desirable to provide means for reducing the number of penetrations through the tubing hanger that are required to enable the use of electric tools that are positioned below the ESP in the well.

### SUMMARY OF THE INVENTION

This disclosure is directed to systems and methods for conveying power and data between surface equipment, an ESP and one or more remote tools while requiring a reduced number of penetrations through a tubing hanger. One embodiment comprises system that includes surface equipment positioned at the surface of a well, an ESP installed downhole in the well, and one or more remote tools which are separate from the ESP and are installed in the well below the ESP. A primary cable that may carry power and data between the surface equipment and the downhole equipment is coupled between the surface equipment and the ESP. A secondary cable which is separate from the primary power cable is coupled between the ESP and the remote tools. The ESP receives power from the surface equipment via the primary cable, and the remote tools receive power from the ESP via the secondary cable. The ESP may have a step-down transformer that transforms received AC power at a higher voltage to lower-voltage AC power or generates a rectified signal which is then provided to the remote tools via the secondary cable. The ESP may include a data transceiver which is configured to communicate data (e.g., sensor data and control information) between the ESP and the surface equipment. The data transceiver may also communicate data between the ESP and the remote tools. The data transceiver enables the communication of data between the surface equipment and the remote tools through the ESP. The ESP may include a gauge package or other sensors, and data from these sensors may be communicated by the data transceiver to the surface equipment. Because the primary cable requires only two penetrations of the tubing hanger for the well, carrying the power and communications for the remote tools through the primary cable and the ESP eliminates the need for additional penetrations to accommodate separate cables for the remote tools.

An alternative embodiment comprises an ESP. The ESP includes a pump and a motor configured to drive the pump. The ESP has a primary cable interface at which a primary cable from surface equipment can be coupled to the ESP. Power can be supplied to the ESP via the primary cable interface, and data can be communicated between the surface equipment and the ESP via the primary cable interface. The ESP may include a step-down transformer that receives AC power at a first voltage and converts it to power at a reduced voltage, or the AC power may be rectified. The reduced-voltage or rectified power can be provided to remote tools that are installed in the well below the ESP. The reduced-voltage power is provided as an output at an interface to a secondary cable that can connect the ESP to the remote tools. The ESP may include a data transceiver that communicates data between the ESP and the surface equipment. The data transceiver may also communicate data received from remote tools to the surface equipment (as well as from the surface equipment to the remote tools). The ESP may include a gauge package, from which sensor data can be collected and communicated to the surface equipment.

Another alternative embodiment comprises a method which is implemented in a system having equipment positioned at the surface of a well, an ESP installed in the well and remote tools installed in the well below the ESP. In this method, a primary cable is coupled between the surface equipment and the ESP. The primary cable may extend through a single penetration in a tubing hanger. A secondary cable which is separate from the primary power cable is coupled between the ESP and the remote tools. AC power is provided from the surface equipment to the ESP through the primary cable. The AC power is provided to the motor of the ESP at a first voltage to run the motor. The AC voltage at the ESP motor is stepped down to a reduced voltage or rectified, and is then provided to the remote tools through the secondary cable. Power is thereby provided to the remote tools without requiring a second penetration of the tubing hanger. The ESP may also include a data transceiver, where the method includes the data transceiver receiving data from the remote tools and communicating the received remote tool data to the surface equipment through the primary cable. The ESP may further include a gauge or sensor package, where the data transceiver receives data from the gauge or sensor package and communicates the received data to the surface equipment through the primary cable along with the remote tool data. The data transceiver may also receive control information from the surface equipment through the primary cable and communicate the control information to the remote tools through the secondary cable.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary system for the production of oil from a subsea well in accordance with one embodiment.

FIGS. 2A and 2B are diagram illustrating connections between surface equipment and equipment installed in a well, and the required penetrations of a tubing hanger.

FIG. 3 is a diagram illustrating an exemplary embodiment in which power and communications for downhole equipment located remotely from an ESP are provided via a power cable of the ESP in accordance with one embodiment.

FIG. 4 is a flow diagram illustrating a method for providing power and communications to downhole equipment located remotely from an ESP in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for providing power and communicating data between surface equipment and downhole tools or devices positioned below an ESP, where electric equipment remote from an ESP and positioned below the ESP in the well receive power via the ESP and communicate with surface equipment through the ESP in order to reduce the number of penetrations that must be made through the tubing hanger in the well.

In one embodiment, an oil production system in a deep sea well includes surface equipment such as a variable frequency drive that is coupled to provide power to an ESP in the well. The surface equipment also includes control systems that communicate information to the ESP and receive information from the ESP. This information is communicated over a high voltage (e.g., 4000V-5000V) power cable that extends from the surface equipment, through a tubing hanger at the well head to the ESP which is supported from the tubing hanger.

The ESP provides high voltage power to a step-down transformer that converts the high voltage to a lower voltage (e.g., 5V). A second power cable is coupled to the step-down transformer to carry the reduced-voltage or rectified power to one or more electric tools that are positioned in the well below the ESP and remotely from the ESP. These remote tools may, for example, include valves or sensors. The remote tools transmit and receive information over the low-voltage power cable to the step-down transformer and ESP, which relays the information to and from the surface equipment over the high-voltage power cable.

Because the power and communications of the remote tools are piggybacked on the ESP's high voltage power cable, they do not require a separate, dedicated TEC line, and do not require a separate penetration of the tubing hanger. This reduces installation costs and simplifies the wellbore construction.

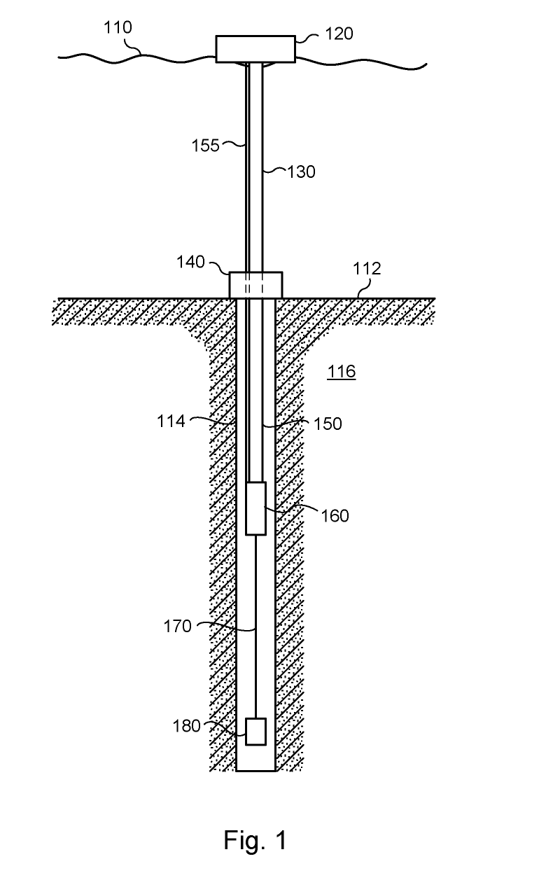

Referring to FIG. 1, a diagram illustrating an exemplary system for the production of oil from a subsea well is shown. In this embodiment, a well 114 has been drilled in a geological formation 116 that lies below the seabed 112. An ESP 160 is positioned in a producing portion of well 114. ESP 160 is coupled to the lower end of production tubing 150, which extends through well head 140 and is coupled to subsea tubing 130. Production tubing 150 and subsea tubing 130 form a conduit through which ESP 160 can pump oil from well 114 to platform 120.

ESP 160 receives power from a drive system (e.g., a variable frequency drive) on platform 120. This high voltage output power is controlled by the drive system to operate the ESP's motor at a desired speed. The output power from the drive system is carried via power cable 155 (which penetrates well head 140) to ESP 160. Power cable 155 is also used to support communications between the equipment on platform 120 and ESP 160. That is, the ESP has a comms-on configuration in which communications between the surface and ESP are impressed on the same conductors in cable 155 that carry the power to the ESP.

In order to optimize the flow of oil that is produced from formation 116, it may be necessary or desirable to provide additional equipment in the well below the ESP. This equipment is positioned remotely from ESP, rather than being attached to the bottom of the ESP as are conventional gauge packages. In this embodiment, power from ESP 160 is provided to remote equipment 180 via a secondary power cable 170. A step-down transformer is coupled between ESP 160 and secondary power cable 170 to convert the power from the high voltage used to drive the ESP to a lower voltage which is suitable for remote equipment 180.

ESP 160 and remote equipment 180 are configured to use secondary power cable 170 for communications as well as power. Data from remote equipment 180 is impressed on the same conductors of secondary cable 170 that carry power to the remote equipment. This data, which is normally intended to be used by surface equipment at platform 120, is received from the remote equipment by ESP 160 and is then retransmitted by the ESP to the surface equipment at the platform. Information can likewise be communicated from the surface equipment to remote equipment 180 over the power cables. Information from the surface equipment is transmitted via power cable 155 to ESP 160, which then forwards the information to remote equipment 180 via secondary power cable 170.

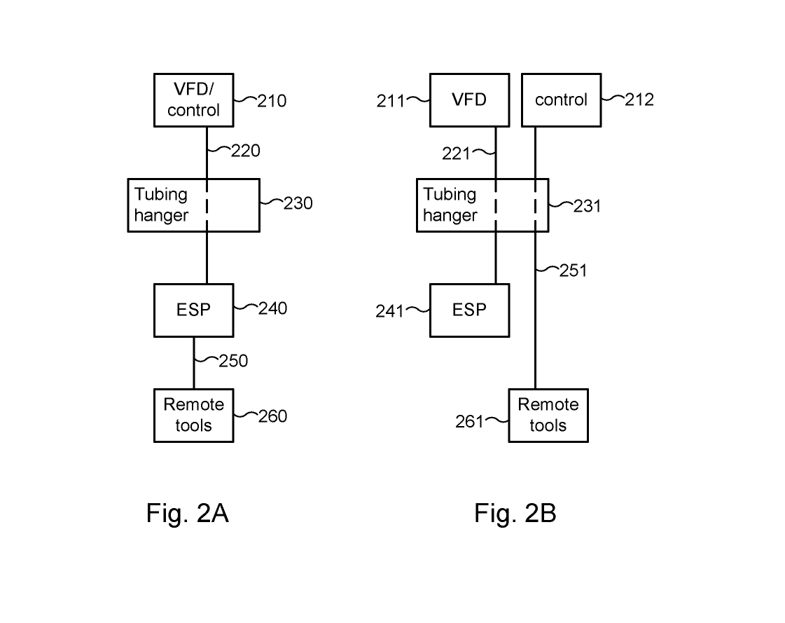

As noted above, this system provides advantages over conventional system, such as the ability to provide power to, and communicate with, tools that are remote from the ESP without requiring additional penetrations through the tubing hanger for power and communication lines that are dedicated to the remote equipment. This is illustrated in FIGS. 2A and 2B. FIG. 2A is a simple functional block diagram depicting the connections between the surface equipment, ESP and remote equipment, and the single penetration of the tubing hanger that is required for the primary power cable. FIG. 2B is a simple functional block diagram depicting the connections between the surface equipment, ESP and remote equipment when the remote equipment is conventionally connected by a dedicated line to the surface equipment.

As shown in FIG. 2A, primary power cable 220 that carries high voltage power from surface equipment 210 to ESP 240, as well as communications between the surface equipment and ESP, is the only line that penetrates tubing hanger 230. By contrast, as depicted in FIG. 2B, a primary power cable 221 carries high voltage power and communications between surface equipment 211 and ESP 241, but a separate dedicated line 251 carries power and communications between the remote tool 261 and the controls 212 for the remote tool. Because power/communication cables 221 and 251 are separate, they require separate penetrations of tubing hanger 231. While only one remote downhole tool (261) is depicted in the figure, there could be additional remote tools in the conventional system, each of which would require a separate power/communication line and a separate penetration of tubing hanger 231.

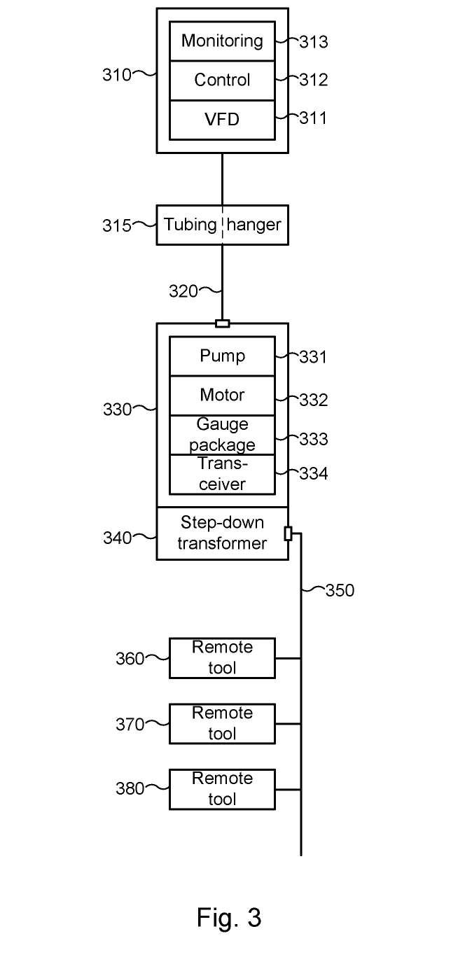

Referring to FIG. 3, a functional block diagram illustrating an exemplary embodiment in more detail is shown. In this figure, the surface equipment 310 includes a variable frequency drive 311 that is configured to provide power to an ESP 330. Surface equipment 310 also includes monitoring and control equipment 312-313, which can receive data from and transmit data to ESP 330 and remote tools 36-38.

The power and data from surface equipment 310 is carried over primary high voltage power cable 320 to ESP 330. Power cable 320 extends through a single penetration of tubing hanger 315. The power produced by VSD 311 drives the motor 332 of the ESP, which drives the pump 331 to force oil through the production tubing and out of the well. Control system 312 and monitoring system 313 communicate with ESP 330 via power cable 320.

ESP 330 includes a motor 332 which receives power from drive 311 and drives a pump 331. In this embodiment, ESP 330 also includes a gauge package 333 that is attached to the bottom of the ESP to monitor parameters associated with the well and/or ESP (e.g., temperature, pressure, fluid flow, etc.) ESP 330 includes a transceiver 334 that is configured to communicate data from the ESP to surface equipment 310. The power for gauge package 333 and transceiver 334 are drawn from the ESP (e.g., tapped from the Y-point of the motor).

A step-down transformer 340 is coupled to ESP 330. Step-down transformer 340 converts the high voltage power on cable 320 to a low voltage that is provided on secondary cable 350 to remote tools 360-380 that are positioned below ESP 330 in the well. Step-down transformer 340 may, for example, step-down the 4000-5000 volts on the primary power cable to a significantly lower AC voltage. Alternatively, a rectifier can convert the AC power to a rectified DC voltage. The reduced-voltage AC power or the rectified DC power is then provided on the secondary power cable. The lower voltage on secondary power cable 350 is suitable to power the remote tools, which may include valves, sensors, fiberoptics, and the like.

Remote tools 360-380 include transceivers that are coupled to secondary power cable 350 so that data generated by these tools can be transmitted over the power cable to the ESP. The transceiver 334 of the ESP is coupled to secondary power cable 350 to receive the data transmitted by remote tools 360-380. This data is retransmitted by the ESP's transceiver over primary power cable 320 to surface equipment 310. Data can also be transmitted from the surface equipment to the remote tools. In this case, the data is transmitted by surface equipment 310 over primary power cable 320 and is received by the ESP's transceiver 334. The transceiver retransmits the data over secondary power cable 350 and is received by the respective transceivers of remote tools 360-380.

Because the power for remote tools 360-380 is drawn from ESP 330, and because the communications between the remote tools and the surface equipment are communicated over the power cables (320, 350), there is no need to provide separate TEC lines for the remote tools. It is therefore possible to provide the additional data generated by the remote tools (which can be used to optimize operation of the well) without the disadvantages of having dedicated power/communication lines, such as having to make corresponding penetrations of the tubing hanger.

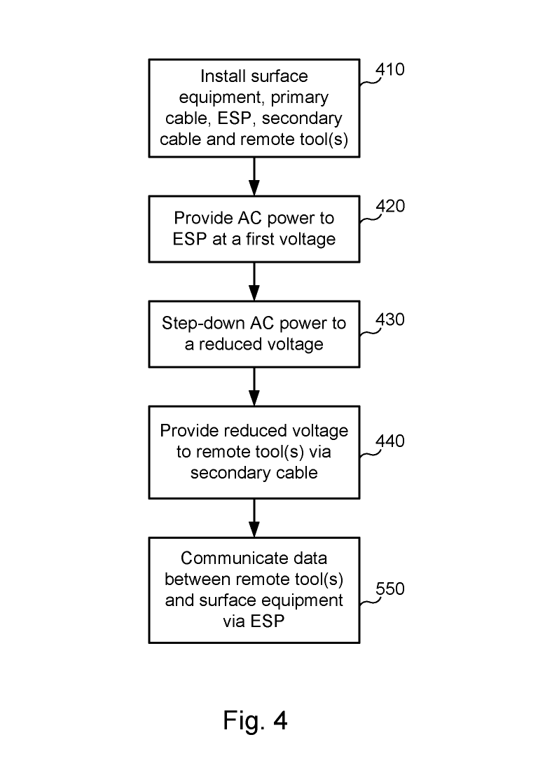

Alternative embodiments of the invention may include methods of making or using systems such as the ones described above. For example, one embodiment is a method as shown in the flowchart of FIG. 4. In this embodiment, a system is installed, where the system includes surface equipment, an ESP installed in the well and remote tools installed in the well below the ESP (410). A primary cable is coupled between the surface equipment and the ESP, and a separate secondary cable is coupled between the ESP and the remote tools (410). AC power is provided from the surface equipment to the ESP through the primary cable (420). The AC power is provided to the motor of the ESP at a high voltage which is suitable to run the motor. The AC voltage at the ESP motor is stepped down to a reduced voltage (430), which is then provided to the remote tools through the secondary cable (440). AC power is thereby provided to the remote tools without requiring a second penetration of the tubing hanger. The ESP may also include a data transceiver, where the method includes the data transceiver receiving data from the remote tools and communicating the received remote tool data to the surface equipment through the primary cable (450). The ESP may further include a gauge package, where the data transceiver receives data from the gauge package and communicates the received gauge package data to the surface equipment through the primary cable along with the remote tool data. The data transceiver may also receive control information from the surface equipment through the primary cable and communicate the control information to the remote tools through the secondary cable.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the present disclosure.

1. A system comprising:
one or more pieces of surface equipment positioned at the surface of a well;
an electric submersible pump (ESP) installed downhole in the well;
a primary power cable coupled between the one or more pieces of surface equipment and the ESP;
one or more remote tools which are separate from the ESP and are installed in the well below the ESP; and
a secondary cable which is separate from the primary power cable, wherein the secondary cable is coupled between the ESP and the one or more remote tools;
wherein the one or more remote tools receives power from the ESP via the secondary cable; and
wherein the one or more remote tools receives power from the surface equipment via the primary power cable, the ESP and the secondary cable, and wherein the one or more remote tools communicates with the surface equipment through the primary power cable, the ESP and the secondary cable.

2. The system of claim 1, further comprising a step-down transformer coupled to the ESP, wherein the step-down transformer steps down an AC voltage at the ESP to a reduced voltage and provides the reduced voltage to the one or more remote tools via the secondary cable.

3. The system of claim 1, further comprising a rectifier coupled to the ESP, wherein the rectifier rectifies an AC voltage that runs a motor of the ESP to a DC voltage and provides the DC voltage to the one or more remote tools via the secondary cable.

4. The system of claim 1, wherein the ESP includes a data transceiver, wherein the data transceiver receives data from the one or more remote tools and communicates the received remote tool data to the surface equipment.

5. The system of claim 4, wherein the ESP includes a sensor package, wherein the data transceiver receives data from the sensor package and communicates the received sensor package data to the surface equipment.

6. The system of claim 1, wherein the ESP includes a data transceiver, wherein the data transceiver receives control information from the surface equipment and communicates the control information to the one or more remote tools.

7. The system of claim 1, wherein communications between the surface equipment and the ESP and communications between the surface equipment and the one or more remote tools are carried through a single common penetration of a tubing hanger.

8. An electric submersible pump (ESP) comprising:
a pump;
a motor coupled to the pump and configured to drive the pump;
a primary cable interface at which AC power at a first voltage is received, wherein the motor is coupled to receive the AC power at the first voltage;
first circuitry configured to receive the AC power at the first voltage and to convert the AC power at the first voltage to a reduced voltage; and
a secondary cable interface coupled to the first circuitry, wherein AC power at the reduced voltage is provided as an output at the secondary cable interface.

9. The ESP of claim 8, wherein the first circuitry is selected from the group consisting of a step-down transformer and a rectifier.

10. The ESP of claim 8, further comprising a data transceiver, wherein the data transceiver receives data from one or more remote tools via the secondary cable interface and outputs the remote tool data at a primary cable interface which is separate from the secondary cable interface.

11. The ESP of claim 10, further comprising a sensor package, wherein the data transceiver receives data from the sensor package and outputs the received sensor package data at the primary cable interface.

12. The ESP of claim 8, further comprising a data transceiver, wherein the data transceiver receives control information at a primary cable interface which is separate from the secondary cable interface and outputs the control information at the secondary interface.

13. A method implemented in a system having equipment positioned at the surface of a well, an electric submersible pump (ESP) installed in the well and remote tools installed in the well below the ESP, the method comprising:
coupling a primary cable between the one or more pieces of surface equipment and the ESP;
coupling a secondary cable which is separate from the primary power cable between the ESP and the one or more remote tools;
providing AC power at a first voltage from the surface equipment to the ESP through the primary cable;
providing the AC power at the first voltage to a motor of the ESP;
converting the AC voltage at the ESP to a reduced voltage; and
providing AC power at the reduced voltage from the ESP to the one or more remote tools through the secondary cable.

14. The method of claim 13, wherein converting the AC voltage at the ESP to the reduced voltage comprises either stepping down the AC voltage at the ESP to a reduced AC voltage or rectifying the AC voltage at the ESP to a reduced DC voltage.

15. The method of claim 13, wherein the ESP includes a data transceiver, the method further comprising the data transceiver receiving data from the one or more remote tools and communicating the received remote tool data to the surface equipment through the primary cable.

16. The method of claim 15, wherein the ESP includes a sensor package, the method further comprising the data transceiver receiving data from the sensor package and communicating the received sensor package data to the surface equipment through the primary cable.

17. The method of claim 13, wherein the ESP includes a data transceiver, the method further comprising the data transceiver receiving control information from the surface equipment through the primary cable and communicating the control information to the one or more remote tools through the secondary cable.

18. The method of claim 13, wherein communicating data between the surface equipment and the ESP and communicating data between the surface equipment and the one or more remote tools comprises communicating data through a single common penetration of a tubing hanger.
